(19) United States
(12) Patent Application Publication
(10) Pub. No.: US 2021/0171278 A1
(43) Pub. Date: Jun. 10, 2021

(54) PACKAGING FOR CHLORINE TABLET

(71) Applicant: EUROTAB, St Just St Rambert (FR)

(72) Inventors: Maryline SANCHEZ, Poligny (FR); Valerie VENET, Orlienas (FR); Lisa NGUON, Saint Etienne (FR)

(21) Appl. No.: 16/771,189

(22) PCT Filed: Dec. 17, 2018
(86) PCT No.: PCT/EP2018/085296

§ 371 Date: Jun. 9, 2020

(30) Foreign Application Priority Data
Dec. 15, 2017 (FR) 1762267
Dec. 20, 2017 (FR) 1762665

(51) Int. Cl. B65D 85/84; B65D 75/04; C11D 17/00; C11D 17/04; C11D 3/395; B65D 65/46

(52) U.S. Cl. CPC B65D 85/84; B65D 75/04; B65D 65/46; C11D 17/044; C11D 3/3955; C11D 17/0073

(57) ABSTRACT

The present invention relates to a packaging comprising at least one tablet individually wrapped in a polymer film, characterised in that the tablet comprises 5% to 100% of active chlorine releasing agent, and the method for preparing same. The present invention also relates to the use of a polymer film for individually wrapping a tablet intended to be placed in a packaging, characterised in that the tablet comprises 5% to 100% of active chlorine releasing agent.

The present invention belongs to the field of chlorine tablets. The present invention relates to a packaging comprising at least one chlorine tablet individually wrapped in a polymer film. The present invention also relates to the use of a polymer film for individually wrapping a chlorine tablet intended to be placed in a packaging.

In the field of chlorine tablets, notably for disinfection or bleaching, two major problems are posed in terms of packaging.

The first problem stems from the fact that the chlorine tablet releases chlorine gas. Several drawbacks are then highlighted. When the consumer opens the packaging containing the tablets, a strong smell of chlorine is released from the packaging. This smell is disagreeable for the consumer. The consumer has a poor perception of the product when he handles it since he is directly in contact with the chemical. A smell may persist on his hands even after washing, there may also be risks of allergies. Another drawback is the swelling of the packaging containing the tablets. This problem leads to the necessity of using non-airtight packaging to evacuate the gases emitted. The use of non-airtight packaging leads to a reduction in the stability of the tablets.

The second problem stems from the disintegration and the dissolution of the chlorine tablets. The chlorine tablets that are currently found on the market do not have both good disintegration and good dissolution of the active chlorine releasing agent. A disintegration time of the tablet less than 5 minutes leads to having a lot of residues of undissolved chlorine agents. This leads to a loss of efficiency, notably for tablets intended to disinfect toilet bowls where it is not possible to agitate the solution. In order to guarantee good dissolution of the granules of chlorine agents, it is necessary to slow down the disintegration of the tablet, which is a drawback for the consumer because said consumer is obliged to wait to use the prepared solution.

The international application WO 2007/130817 pertains to a water soluble film resistant to halogens. The chlorine product packaged in said water soluble film is not stored in a airtight packaging, which poses a problem of stability of the product over time, notably when the product is stored in humid or hot conditions.

The present invention relates to a packaging (3) comprising at least one tablet (1) individually wrapped in a polymer film (2), characterised in that the tablet comprises 5% to 100%, preferably 5% to 99.9% of active chlorine releasing agent.

The present invention also relates to the use of a polymer film (2) for individually wrapping a tablet (1) intended to be placed in a packaging (3), characterised in that the tablet comprises 5% to 100% by weight, preferably 5% to 99.9% by weight of active chlorine releasing agent, compared to the total weight of the tablet.

The inventors have discovered in a surprising manner that the addition of a polymer film (primary packaging) around a chlorine tablet make it possible to avoid the release of chlorine gas in the secondary packaging and thus to avoid the disagreeable smell during opening.

Moreover, until now, the problem linked to swelling and to the undesirable coloration of secondary packaging containing chlorine products has never been tackled in the prior art. Indeed, according to the general knowledge of those skilled in the art at the date of the present invention, this problem results uniquely from an exposure to humidity, an incorrect closing of the packaging, or any other reason linked to the external environment. Thus, the inventors have discovered that the swelling and undesirable coloration of secondary packaging containing chlorine products is not due to the external environment but is due to the release of chlorine by the chlorine tablet. The inventors then discovered that the addition of a polymer film (primary packaging) around a chlorine tablet thus makes it possible to avoid the release of chlorine gas in the secondary packaging and thus avoid swelling and undesirable coloration of the secondary packaging containing said chlorine products.

The fact of preventing the release of chlorine gas thus makes it possible to improve the resistance and the stability of the tablet and the secondary packaging over time. In addition, the secondary packaging may be completely airtight from the external environment without risking swelling or undesirable coloration, thus making it possible to improve the stability of the product. It is thus possible to store the chlorine tablets in all types of secondary packaging, notably airtight packaging, without risk of alteration.

The inventors have also discovered in a surprising manner than when the tablet is packaged in a water soluble polymer film, it is possible to obtain, in aqueous solution, both good disintegration of the tablet and good dissolution of the active chlorine releasing agent in the solution, and this is so for rapid disintegration times, that is to say less than 5 minutes. This thus makes it possible to obtain rapidly a solution releasing active chlorine, which can be used by the consumer practically immediately and especially without agitation. For example, this invention makes it possible to respond to the drawbacks posed within the context of disinfection of toilet bowls where agitation is difficult. This also makes it possible not to have to remove the polymer film, which limits the number of manipulations to carry out.

The present invention thus makes it possible to propose a solution to the different drawbacks encountered in the prior art.

Thus, the present invention mainly relates to a packaging (3) comprising at least one tablet (1) individually wrapped in a polymer film (2), characterised in that the tablet comprises 5% to 100% by weight, preferably 5% to 99.9% by weight of active chlorine releasing agent, compared to the total weight of the tablet.

### Packaging

Within the scope of the present invention, the packaging (3), also called secondary packaging, may be any type of packaging making it possible to store tablets. Advantageously, the packaging is a bag, a pot, a carton, a box, a case or a bucket. The packaging may be made of any type of material, such as plastic, cardboard, metal or glass.

Preferably, the packaging according to the invention is a bag.

Preferably, the packaging according to the invention is an airtight packaging, preferably an airtight bag.

Within the scope of the present invention, “airtight packaging” means all types of recipients which, in the closed state, are airtight to the external environment, that is to say which prohibit any circulation between their internal and external environments. The airtight packaging is notably leak tight to all types of gases, in particular air, water and water vapour. The term “hermetic packaging” may be used synonymously. Within the scope of the present invention, the airtight packaging may be considered as a secondary packaging of the tablet (1).

The airtight packaging may advantageously be in the form of a bag, a pot, a carton, a box, a case or a bucket, preferably the airtight packaging is a bag.

The airtight packaging may be composed for example of simple plastics such as polyethylene terephthalate (PET), polyethylene (PE), polystyrene (PS), polyvinyl chloride (PVC), polypropylene (PP) or complex plastics comprising polyethylene terephthalate (PET), polyethylene (PE), polystyrene (PS), polyvinyl chloride (PVC), polypropylene (PP), aluminium, paper such as kraft paper or paper derived from recycled fibres, ethylene vinyl alcohol (EVOH) copolymer, PET with SiOx treatment, polyamide (PA) or mixtures thereof. Preferably, the airtight packaging is composed of a PET/PE complex.

Advantageously, the packaging, notably the airtight packaging, is closed according to methods known to those skilled in the art such as hot or cold sealing, screwing and all other methods known to those skilled in the art. The method for closing the packaging, and notably the airtight packaging, may easily be adapted by those skilled in the art as a function of the type of packaging used. For example, an airtight packaging in the form of pot will be preferably closed by screwing whereas an airtight packaging in the form of bag will be preferably closed by hot or cold sealing.

The packaging, notably the airtight packaging according to the present invention, may comprise one or more tablet(s) individually wrapped in a polymer film. The airtight packaging may thus be an individual packaging (FIG. 2A) or not (FIG. 2B). Those skilled in the art will easily know how to adapt the size of the packaging as a function of the number of tablets that it may comprise.

### Chlorine Tablet

Within the scope of the present invention, “tablet” or “chlorine tablet” means a composition constituted of an assembly of particles grouped together in a compact manner so as to be able to be handled without breaking up. Said compact composition comprises 5% to 100% of a chlorine releasing agent, preferably 5% to 99.9%, compared to the total weight of the composition.

“Chlorine releasing agent” or “chlorine agent” means, within the meaning of the present invention, a compound making it possible to release chlorine in a solution, notably an aqueous solution. Advantageously, the chlorine releasing agent is chosen from alkali metal hypochlorites, chlorinated trisodium phosphates, chlorinated sulphonamides, halogenated hydantoins, polychlorocyanurates such as alkali metal polychlorocyanurates and notably dichloroisocyanurates such as sodium or potassium dichloroisocyanurates, and mixtures thereof. More advantageously, the chlorine agent is chosen from dichloroisocyanurates. The chlorine agent is more particularly chosen from sodium dichloroisocyanurate, potassium dichloroisocyanurate, or mixtures thereof, preferably sodium dichloroisocyanurate. Sodium dichloroisocyanurate (or NaDCC) is a stable source of free chlorine which, in an aqueous solution, breaks down into isocyanuric acid, hypochlorous acid (weak acid of chemical formula HOCl which only exists in solution) which is a disinfecting agent, sodium hypochlorite (NaClO), and sodium cyanurate, which plays a role of stabiliser by protecting the hypochlorous acid HOCl and the hypochlorite ion ClO⁻ from decomposition by ultraviolet.

The sodium and potassium dichloroisocyanurates may be anhydrous, hydrated or dihydrated, advantageously dihydrated.

The sodium and potassium dichloroisocyanurates may be in amorphous or crystalline form.

Advantageously, the active chlorine releasing agent is present in the tablet of the invention at a content ranging from 5% to 99.9%, more advantageously 7.5% to 99.9%, preferably 20% to 99.9%, preferably 40% to 99.9%, preferably 50% to 99.9%, notably 50% to 90% and further preferably 60 to 85%, by weight compared to the total weight of the product.

The tablet according to the invention further comprises a filler and/or an effervescent agent (or a pair of agents).

Thus, the tablet according to the invention may comprise at least one filler. Advantageously, the filler content in the tablet is comprised between 0 and 95%, more advantageously 0.1 to 95% by weight, preferably 0.1 to 90% by weight, more advantageously 0.1% to 80%, preferably 0.1% to 60% preferably 0.5% to 50%, preferably 10% to 50%, further preferably 15 to 40% by weight, compared to the total weight of the composition.

As filler suitable for the tablet according to the invention, it is possible to cite inorganic compounds such as zeolites, phyllosilicates, alkali metal carbonates (for example sodium carbonate), sodium silicates, sodium bicarbonate, sodium chloride, weak acids (such as malic acid and adipic acid), neutral pH fillers (such as sodium sulphate); organic compounds such as polycarboxylate polymers (such as polyacrylates, acrylic/maleic copolymers and acrylic phosphonates), polycarboxylate monomers (such as citrates, gluconates, oxydisuccinates, mono-, di- and tri-succinates of glycerol, carboxymethyloxysuccinates, amino polycarboxylic compounds, dipicolinates, nitrilotriacetates and hydroxyethyliminodiacetates); phosphates and polyphosphates; and mixtures thereof. Advantageously, the filler is chosen from sodium bicarbonate.

The tablet according to the invention may also comprise an effervescent agent. Preferably, the content of effervescent agent in the tablet is comprised between 0.1 and 95% by weight, preferably 0.1 to 90% by weight, more advantageously 0.1% to 80%, preferably 0.1% to 60%, preferably 0.5% to 50%, preferably 10% to 50%, further preferably 15 to 40% by weight, compared to the total weight of the composition.

Within the meaning of the present invention, “effervescent agent” means a compound capable of releasing gas when it is brought into contact with water or another liquid. The effervescent agent more particularly enables the tablet to fragment and/or to dissolve rapidly in water or another liquid, notably in an aqueous solution. The effervescent agent may be in particular chosen from organic acids, anhydrides or salts thereof (such as adipic acid, citric acid, malic acid, tartric acid, malonic acid, fumaric acid, maleic acid, succinic acid and mixtures thereof), carbonates or bicarbonates (such as sodium carbonate or bicarbonate, potassium carbonate or bicarbonate, calcium carbonate or bicarbonate, magnesium carbonate or bicarbonate and mixtures thereof), and a mixture thereof. More advantageously, the effervescent agent is a mixture of sodium bicarbonate and an organic acid, notably adipic acid or citric acid. Preferably, the effervescent agent is a sodium bicarbonate/adipic acid pair.

According to an embodiment of the invention, the tablet comprises an effervescent agent and a filler. Advantageously, the total content of filler and effervescent agent in the tablet is then comprised between 0.1 and 95% by weight, preferably 0.1 to 90% by weight, more advantageously 0.1% to 80%, preferably 0.1% to 60%, preferably 0.5% to 50%, preferably 10% to 50%, further preferably 15 to 40% by weight, compared to the total weight of the composition.

The tablet according to the invention may further comprise a disintegrating agent. Advantageously, the disintegrating agent is present in the composition at a content comprised between 0 and 40% by weight, preferably 0% and 10% by weight, compared to the total weight of the composition.

Within the meaning of the present invention, “disintegrating agent” or “disintegration agent” means a solid compound soluble in an aqueous solution and rapidly dissolving in aqueous solution, which makes it possible to improve the permeability of a solid composition when it is brought into contact with an aqueous solution. The disintegrating agent may in particular be chosen from derivatives of polyacrylates, polyvinylpyrrolidones, cellulose derivatives and mixtures thereof.

The tablet according to the invention may further comprise additional compounds such as binding agents, anti-scaling agents, anionic surfactants, cationic surfactants, non-ionic surfactants, optical brighteners, complexing systems, dispersants, enzymes, colorants, fragrances and mixtures thereof.

All the compounds present in the tablet, that is to say present in the compacted composition, are preferably initially supplied in powder form.

According to an advantageous embodiment of the invention, the tablet according to the invention comprises between 5 and 99.9% of active chlorine releasing agent and between 0.1 and 95% of filler, preferably between 60 and 85% of active chlorine releasing agent and between 15 and 40% of filler. The active chlorine releasing agent and filler being such as defined above.

According to an advantageous embodiment of the invention, the tablet according to the invention comprises between 5 and 99.9% of active chlorine releasing agent and between 0.1 and 95% of effervescent agent, preferably between 60 and 85% of active chlorine releasing agent and between 15 and 40% of effervescent agent. The active chlorine releasing agent and the effervescent agent being such as defined above.

According to another advantageous embodiment of the invention, the tablet according to the invention comprises between 5 and 99.9% of active chlorine releasing agent, between 0.1 and 95% of filler and effervescent agent (total content), preferably between 60 and 85% of active chlorine releasing agent, between 15 and 40% of filler and effervescent agent (total content). The active chlorine releasing agent, the filler and the effervescent agent being such as defined above.

The tablet according to the present invention has a weight comprised between 0.5 and 1000 grams, notably between 0.5 and 500 grams, preferably between 0.5 and 100 grams, and further preferably between 0.5 and 50 grams. This tablet may be round, oval, octagonal, parallelepiped (square, rectangular, etc.), or polygonal shape. Preferably the tablet will be of round shape. The tablet may have upper and lower faces that are flat or curved, concave or convex.

The chlorine tablet according to the invention may be constituted of a layer or a stack of several layers which are superimposed on each other, thus forming a uniform and compact block. The layers may be of similar or different compositions, or even similar or different colours.

The tablet has a mechanical strength comprised between 10 N and 5000 N, advantageously between 30 N and 3000 N, in a more preferred manner between 50 N and 1500 N.

The chlorine tablet according to the invention may in particular be manufactured according to the following preparation method:

a) mixing the different components in powder form in a homogeneous manner, including at least one chlorine releasing agent, to form a composition;

b) pre-compacting the composition, in particular by direct compression, for example on rotary presses;

c) optionally, introducing on the first layer obtained at step b) a composition such as obtained at step a) to form a second layer then pre-compacting the new composition as carried out at step b);

d) optionally renewing step c) as many times as there are necessary layers; and

e) compacting the layer obtained at step b) or the set of layers obtained at step c) or d), in particular by direct compression, for example on rotary presses, to obtain a compacted composition.

The pre-compaction forces used are in particular comprised between 5 kN and 200 kN, advantageously between 5 kN and 100 kN and more advantageously between 10 kN and 80 kN. The compaction force used is in particular comprised between 20 kN and 1000 kN, advantageously between 40 kN and 600 kN and more advantageously between 60 kN and 250 kN.

The compacted composition thus obtained is impact resistant.

### Polymer Film

“Polymer film” means, within the meaning of the present invention, a polymer film, preferably flexible, intended to wrap directly and individually a tablet such as defined above. Within the scope of the present invention, the polymer film may be considered as the primary packaging of the tablet (1).

Within the scope of the present invention, the inventors have discovered in a surprising manner that, whatever the composition of the polymer film is, the latter makes it possible to retain chlorine gas, thus making it possible to avoid swelling and/or deterioration of the secondary packaging, notably airtight.

The polymer film comprises at least one polymer, advantageously chosen from polyvinyl alcohol (PVAL), polypropylene, bi-oriented polypropylene, metallised polypropylene, polyethylene, polyolefins, polyethylene terephthalate, polyvinyl chloride and a polymer of biological origin based on corn starch or milk protein.

The polymer film further comprises other agents such as plastifiers, additives, colorants, antistatic agents, or mixtures thereof.

Within the scope of the present invention, the polymer film may be non-soluble in water or water soluble.

Within the scope of a polymer film non-soluble in water, the polymer is advantageously chosen from polypropylene, bi-oriented polypropylene, metallised polypropylene, polyethylene, polyolefins, polyethylene terephthalate and polyvinyl chloride.

Within the scope of a water soluble polymer film, the polymer is advantageously chosen from polyvinyl alcohol (PVAL or PVOH) and a polymer of biological origin based on corn starch or milk protein. Preferably, the water soluble film comprises polyvinyl alcohol (PVAL).

Preferably, the polymer film is water soluble. When the tablet is wrapped in a water soluble film, it is possible to obtain both good disintegration of the tablet as well as good dissolution of the active chlorine releasing agent (NaDCC) in the solution, and this is so for disintegration times less than 5 minutes. Indeed, when a water soluble film is used, the user does not need to remove the tablet from its water soluble wrapping; the water soluble film is thus going to play a role in the disintegration and the dissolution of the tablet.

Advantageously, the polymer film is water soluble and biodegradable.

Advantageously, the polymer film has a thickness comprised between 10 and 100 μm, preferably between 10 and 50 μm, and further preferably between 10 and 35 μm.

Advantageously, the polymer film is closed around the tablet according to methods known to those skilled in the art such as the hot or cold sealing.

Within the scope of the invention, the tablet is packaged individually in the polymer film. After closing, the polymer film may be cut in order to form a tablet wrapped with the individual polymer film, or the polymer film may again be filled by a new tablet before being closed once again. This latter situation represents a string of several tablets individually wrapped. When the desired number of tablets in the string is reached, the polymer film is cut.

Within the scope of the present invention, the packaging and the polymer film may be closed around the tablet in a separate manner. Thus, to access the tablet, two manipulations are necessary: the opening of the secondary packaging then the opening of the polymer film (except if the latter is water soluble and may thus be conserved around the tablet during use).

### Method

The present invention also relates to a method for preparing a packaging (3) comprising at least one tablet (1) individually wrapped in a polymer film (2), characterised in that the tablet comprises 5% to 100%, preferably 5% to 99.9%, by weight of active chlorine releasing agent, said method comprising the following steps:
a) Preparation of the tablet (1) comprising 5% to 100%, preferably 5% to 99.9%, by weight of active chlorine releasing agent;
b) Incorporation of the tablet (1) obtained at step a) in the polymer film (2);
c) Closing of the polymer film wrapping said tablet (1);
d) Optionally, repeating steps a) to c) until the desired number of wrapped tablets is obtained;
e) Cutting the polymer film after step c) or step d);
f) Incorporation of the wrapped tablet(s) obtained at step e) in the packaging (3); and
g) Closing the packaging (3).

The packaging, the chlorine tablet and the polymer film are such as defined above.

Step a) may be carried out easily by those skilled in the art using their general knowledge. An example of preparation of the tablet is such as described above.

Steps b) and f) may be carried out easily by those skilled in the art using their general knowledge. Steps b) and f) may for example be carried out manually or industrially.

The polymer film is closed (step c)) around the tablet according to methods known to those skilled in the art such as hot or cold sealing.

Advantageously, after the closing step c), either the polymer film is cut during a step e) to form an individually wrapped tablet, or step d) is carried out without cutting the polymer film to obtain a string of several individually wrapped tablets then the polymer film is cut during a step e) when the desired number of tablets in the string is reached.

The packaging is closed (step g)) according to methods known to those skilled in the art such as hot or cold sealing, screwing and all other methods known to those skilled in the art. The method for closing the packaging may easily be adapted by those skilled in the art as a function of the type of packaging used. For example, an airtight packaging in the form of pot will be preferably closed by screwing whereas an airtight packaging in the form of bag will be preferably closed by hot or cold sealing.

### Use

The present invention also relates to the use of a polymer film (2) for individually wrapping a tablet (1) intended to be placed in a packaging (3), characterised in that the tablet comprises 5% to 100%, preferably 5% to 99.9% of chlorine agent.

The packaging, the chlorine tablet and the polymer film are such as defined above.

### DESCRIPTION OF THE FIGURES

FIG. 1 represents a tablet (1) individually wrapped in a polymer film (2). The polymer film (2) completely wraps the tablet (1).

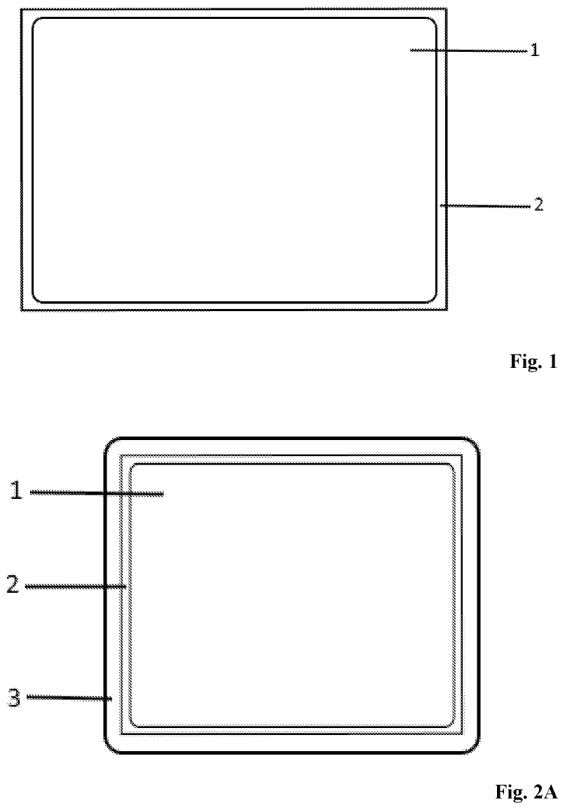

FIGS. 2A and 2B represent a packaging, notably an airtight packaging (3) comprising a tablet (1) individually wrapped in a polymer film (2). The polymer film (2) completely wraps the tablet (1). FIG. 2A shows a packaging, notably an individually airtight packaging (3) and FIG. 2B shows a packaging, notably an airtight packaging (3) being able to comprise several film wrapped tablets.

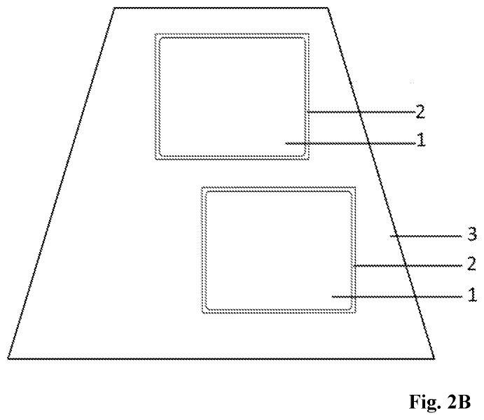

The examples that follow aim to illustrate the present invention.

### EXAMPLES

### Example 1: Comparison of the Disintegration Time and the Stability of Tablets Packaged According to the Invention with Non-Film Wrapped Tablets or Tablets not Placed in a Airtight Packaging

In this example, we compared the disintegration time and the stability of tablets based on NaDCC (sodium dichloroisocyanurate) strictly identical in composition, weight, shape and method of implementation thereof.

The tablets tested have a weight of 5 grams, of cylindrical shape of 20 mm diameter. The composition of these tablets is summarised in table 1 below:

TABLE 1
Composition of the tested tablets

| | Percentage by weight compared to the total |
|---|---|
| Name | weight of the tablet |
| NaDCC | 80 |
| Sodium bicarbonate | 12 |
| Adipic acid | 8 |

These tablets were produced on rotary press with the same compressive force, namely 90 kN.

The tablets thus obtained were next individually wrapped in a polymer film (Flowpack) or not, as described in table 2 below. The tablets were next placed in a secondary packaging, airtight or not, as described in table 2 below.

TABLE 2
Description of the tests

| | | | Number |
|---|---|---|---|
| Test | Type of | Type of secondary | of |
| No | Flowpack | packaging | tablets |
| Test | No Flowpack | Flexible airtight bag based | 30 |
| 1-NF | | on PET (polyethylene | |
| | | terephthalate) (12 μm)/PE | |
| | | (polyethylene) (90 μm), of | |
| | | dimensions 160 × 195 mm | |
| | | (also called Doypack) | |
| Test | Film made of | Flexible airtight bag based | 30 |
| 2-PP | bi-oriented | on PET (polyethylene | |
| | polypropylene | terephthalate) (12 μm)/PE | |
| | (PP) of | (polyethylene) (90 μm), of | |
| | 30 μm thickness | dimensions 160 × 195 mm | |
| | | (also called Doypack) | |
| Test 3- | Polyvinyl | Flexible airtight bag based | 30 |
| PVOH | alcohol (PVOH) | on PET (polyethylene | |
| | based film of | terephthalate) (12 μm)/PE | |
| | 30 μm thickness | (polyethylene) (90 μm), of | |
| | | dimensions 160 × 195 mm | |
| | | (also called Doypack) | |
| Test | Film made of | Flexible airtight bag based | 30 |
| 4-PE | polyethylene | on PET (polyethylene | |
| | (PE) of 30 μm | terephthalate) (12 μm)/ | |
| | thickness. | PE (polyethylene) (90 μm), | |
| | | of dimensions 160 × 195 mm | |
| | | (also called Doypack) | |
| Test | No Flowpack | Airtight pot made of high | 30 |
| 5-NF | | density polyethylene | |
| | | associated with a hermetic | |
| | | lid made of polypropylene, | |
| | | of dimensions 116 × 60 mm | |
| Test | No Flowpack | Non-airtight box (sensitive | 30 |
| 6-NF | | to humidity) of cardboard | |
| | | type of 1 mm thickness, of | |
| | | dimensions 60 × 85 × 80 mm | |
| Test 7- | Film based on | Non-airtight box (sensitive to | 30 |
| PVOH | polyvinyl alcohol | humidity) of cardboard type | |
| | (PVOH) of | of 1 mm thickness, of | |
| | 30 μm thickness | dimensions 60 × 85 × 80 mm | |

The packagings containing the tablets were next placed in a climatic chamber at 38° C. and 46% relative humidity. These conditions enable accelerated ageing to be carried out: 1 week represents six months of stability at ambient temperature. The ageing of these tablets was monitored over one month in a climatic chamber, which corresponds to two years of stability at ambient temperature. Each week, the following measurements were carried out on the tablets:
Appearance
Diametral hardness
Disintegration time
Active chlorine measurement
Quantity of chlorine gas released
Chorine smell measured by a consumer panel

The appearance of the tablets was evaluated by visual observation.

The diametral hardness of the tablets was measured using a hardness tester of Dr Schleuniger 8M type and is expressed in Newtons (N).

The disintegration time of the tablets was measured statically in a beaker of one litre of water at 20° C.

The concentration of active chlorine was measured by iodometric assay. The reagents used were the following: 0.024N sodium thiosulfate, 10% KI solution, 4N sulphuric acid and 5 g/L solution of starch paste.

The quantity of chlorine gas released was measured using a GASTEC N^{o} 0.8La type measurement kit. This is a colorimetric reagent tube.

The measurement of the chlorine smell was evaluated immediately after taking the packagings out of the climatic chamber by a consumer panel of ten persons. A rating was assigned by each person: 10 strong smell, 5 mild smell, 0 no smell. An average of the ratings obtained was made for each measurement.

The results obtained are summarised in tables 3 to 5 below:

TABLE 3
Monitoring of the appearance, hardness and disintegration of the tablets

| | | | T = 1 | T = 2 | T = 3 | | T = 4 | |
|---|---|---|---|---|---|---|---|---|
| Tests | Tests | T = 0 | week | weeks | weeks | | weeks | |
| Appearance | Test 1- | ok | ok | Start of | Swelling | | Swelling | |
| of tablets | NF-ES | | | swelling | | | | |
| | Test 2- | ok | ok | ok | ok | | ok | |
| | PP-ES | | | | | | | |
| | Test 3- | ok | ok | ok | ok | | ok | |
| | PVOH-ES | | | | | | | |
| | Test 4- | ok | ok | ok | ok | | ok | |
| | PE-ES | | | | | | | |
| | Test 5- | Ok | Ok | Start of | Swelling | | Swelling | |
| | NF-EP | | | swelling | | | | |
| | Test 6- | ok | Ok | Start of | Swelling | | Swelling | |
| | NF-NE | | | swelling | | | | |
| | Test 7- | ok | ok | ok | ok | | ok | |
| | PVOH-NE | | | | | | | |
| Hardness | Test 1- | 110N | 155N | 162N | 197N | | 200N | |
| of tablets | NF-ES | | | | | | | |
| | Test 2- | 110N | 132N | 143N | 156N | | 158N | |
| | PP-ES | | | | | | | |
| | Test 3- | 110N | 137N | 148N | 160N | | 162N | |
| | PVOH-ES | | | | | | | |
| | Test 4- | 110N | 135N | 147N | 158N | | 163N | |
| | PE-ES | | | | | | | |
| | Test 5- | 110N | 153N | 165N | 193N | | 205N | |
| | NF-EP | | | | | | | |
| | Test 6- | 110N | 155N | 163N | 195N | | 201N | |
| | NF-NE | | | | | | | |
| | Test 7- | 110N | 138N | 146N | 157N | | 161N | |
| | PVOH-NE | | | | | | | |
| Disintegration | Test 1- | 3 minutes | 5 minutes | 7 minutes | 10 | minutes | 13 | minutes |
| of tablets | NF-ES | | | | | | | |
| | Test 2- | 3 minutes | 4 minutes | 4 minutes | 5 | minutes | 5 | minutes |
| | PP-ES | | | | | | | |
| | Test 3- | 2 minutes | 2 minutes | 3 minutes | 5 | minutes | 6 | minutes |
| | PVOH-ES | | | | | | | |
| | Test 4- | 3 minutes | 3 minutes | 5 minutes | 6 | minutes | 7 | minutes |
| | PE-ES | | | | | | | |
| | Test 5- | 3 minutes | 5 minutes | 8 minutes | 10 | minutes | 12 | minutes |
| | NF-EP | | | | | | | |
| | Test 6- | 3 minutes | 4 minutes | 7 minutes | 10 | minutes | 11 | minutes |
| | NF-NE | | | | | | | |
| | Test 7- | 3 minutes | 4 minutes | 4 minutes | 5 | minutes | 6 | minutes |
| | PVOH-NE | | | | | | | |

| | | | | | | |
|---|---|---|---|---|---|---|
| Concentration of | Test 1- | 41% | 38% | 36% | 33% | 32% |
| active chlorine | NF-ES | | | | | |
| | Test 2- | 41% | 40% | 40% | 39% | 39% |
| | PP-ES | | | | | |
| | Test 3- | 41% | 39% | 39% | 37% | 37% |
| | PVOH-ES | | | | | |
| | Test 4- | 41% | 40% | 40% | 40% | 39% |
| | PE-ES | | | | | |
| | Test 5- | 41% | 39% | 35% | 32% | 31% |
| | NF-EP | | | | | |
| | Test 6- | 41% | 38% | 34% | 32% | 30% |
| | NF-NE | | | | | |
| | Test 7- | 41% | 41% | 39% | 39% | 38% |
| | PVOH-NE | | | | | |

NF = non Flowpacked - ES = airtight packaging of bag type - EP = airtight packaging of pot type - NE = non-airtight packaging

TABLE 4
Monitoring of the quantity of chlorine gas released

| | | | T = 1 | T = 2 | T = 3 | T = 4 |
|---|---|---|---|---|---|---|
| Test | Test | T = 0 | week | weeks | weeks | weeks |
| Measurement | Test 1 - | 1 ppm | 1 ppm | 1.3 ppm | 1.6 ppm | 2 ppm |
| of chlorine | NF-ES | | (Doypack | (Doypack | (Doypack | (Doypack |
| gas released | | | yellowing and | slightly | slightly | swollen and |
| in the | | | start of | swollen and | swollen and | delaminated |
| packaging | | | degradation) | delaminated, | delaminated | yellowing) |
| | | | | yellowing) | yellowing) | |
| | Test 2- | 0 ppm | 0.01 ppm | 0.01 ppm | 0.01 ppm | 0.01 ppm |
| | PP-ES | | (Doypack ok) | (Doypack ok) | (Doypack ok) | (Doypack ok) |
| | Test 3- | 0 ppm | 0.01 ppm | 0.01 ppm | 0.01 ppm | 0.01 ppm |
| | PVOH-ES | | (Doypack ok) | (Doypack ok) | (Doypack ok) | (Doypack ok) |
| | Test 4- | 0 ppm | 0.01 ppm | 0.01 ppm | 0.01 ppm | 0.01 ppm |
| | PE-ES | | (Doypack ok) | (Doypack ok) | (Doypack ok) | (Doypack ok) |

TABLE 5
Monitoring of the chlorine smell by a consumer pane

| | | | T = 1 | T = 2 | T = 3 | T = 4 |
|---|---|---|---|---|---|---|
| Test | Test | T = 0 | week | weeks | weeks | weeks |
| Measurement | Test 1 - | 6 | 8 | 8 | 8 | 10 |
| of the | NF-ES | | | | | |
| chlorine | Test 2- | 0 | 0 | 0 | 0 | 1 |
| smell | PP-ES | | | | | |
| | Test 3- | 0 | 0 | 0 | 0 | 2 |
| | PVOH-ES | | | | | |
| | Test 4- | 0 | 0 | 0 | 0 | 2 |
| | PE-ES | | | | | |

The results of this study show that the use of a Flowpack (tests 2 to 4) makes it possible to improve the stability of the tablets because the disintegration time does not increase or only slightly increases and the concentration of active chlorine remains stable unlike the non-film wrapped tablets (test 1). In addition, the measurement of the released gases and the measurement of the chlorine smell by the consumer panels show that the Flowpack makes it possible to retain the chlorine gas released inside the Flowpack.

### Example 2: Comparison of the Disintegration Time and the Stability of Tablets Packaged According to the Invention with Non-Film Wrapped Tablets

In this example, we compared the stability of tablets based on NaDCC strictly identical in composition, weight, shape and implementation method thereof.

The tablets have a weight of 5 grams, of cylindrical shape of 20 mm diameter. The composition of the tablets is summarised in table 6 below:

TABLE 6
Composition of the tested tablets

| | Percentage by weight compared |
|---|---|
| Nom | to the total weight of the tablet |
| NaDCC | 64 |
| Sodium bicarbonate | 20 |
| Adipic acid | 16 |

These tablets were all produced on a rotary press at the same compressive force, namely 90 kN. Among all the tablets produced, thirty tablets were film wrapped with a film made of polyethylene of 30 μm thickness (test 5-PE). The latter were next placed in an airtight packaging, of dimensions 160×195 mm, Kraft based (35 μm)/PET (12 μm)/PE (90 μm). Thirty other non-film wrapped tablets (test 6-NF) were placed in the same airtight packaging base Kraft/PET/PE. Each of the tablets of a same category were placed in a same bag.

These two packagings containing the tablets were next placed in a climatic chamber at 38° C. and 46% relative humidity. These conditions make it possible to carry out accelerated ageing: 1 week represents six months of stability at ambient temperature. The ageing of these tablets was monitored for a month in a climatic chamber, which corresponds to two years of stability at ambient temperature. Each week, the following measurements were carried out on the tablets:
Appearance
Diametral hardness
Disintegration time
Measurement of the active chlorine
Quantity of chlorine gas released
Measurement of the chlorine smell by a consumer panel

The appearance of the tablets was evaluated by visual observation.

The diametral hardness of the tablets was measured using a hardness tester of Dr Schleuniger 8M type and is expressed in Newtons (N).

The disintegration time of the tablets was measured statically in a beaker of one litre of water at 20° C.

The concentration of active chlorine was measured by iodometric assay. The reagents used were the following: 0.024N sodium thiosulfate, 10% KI solution, 4N sulphuric acid and 5 g/L starch paste solution.

The quantity of chlorine gas released was measured using a GASTEC N^{o} 8La type measurement kit. This is a colorimetric reagent tube.

The measurement of the chlorine smell was evaluated immediately after taking the packagings out of the climatic chamber by a consumer panel of ten persons. A rating was assigned by each person: 10 strong smell, 5 mild smell, 0 no smell. An average of the ratings was calculated for each measurement.

The results obtained are summarised in tables 7 to 9 below:

TABLE 7
Monitoring of the appearance, hardness and disintegration of the tablets

| | | | T = 1 | T = 2 | | T = 3 | | T = 4 | |
|---|---|---|---|---|---|---|---|---|---|
| Tests | Tests | T = 0 | week | weeks | | weeks | | weeks | |
| Appearance | Test 6-NF | ok | ok | Start of | | Swelling | | Swelling | |
| of tablets | | | | swelling | | | | | |
| | Test 5-PE | ok | ok | ok | | Ok | | ok | |
| Hardness of | Test 6-NF | 110N | 155N | 162N | | 197N | | 200N | |
| tablets | Test 5-PE | 110N | 134N | 145N | | 155N | | 159N | |
| Disintegration | Test 6-NF | 6 minutes | 8 minutes | 10 | minutes | 10 | minutes | 11 | minutes |
| of tablets | Test 5-PE | 6 minutes | 7 minutes | 7 | minutes | 8 | minutes | 8 | minutes |

| | | | | | | |
|---|---|---|---|---|---|---|
| Concentration | Test 6-NF | 37% | 34% | 33% | 30% | 28% |
| of active | Test 5-PE | 37% | 37% | 35% | 34% | 34% |
| chlorine | | | | | | |

TABLE 8
Monitoring of the quantity of chlorine gas released

| | | | T = 1 | T = 2 | T = 3 | T = 4 |
|---|---|---|---|---|---|---|
| Test | Test | T = 0 | week | weeks | weeks | weeks |
| Measurement | Test 6-NF | 1 ppm | 1 ppm | 1.3 ppm | 1.6 ppm | 2 ppm |
| of chlorine | | | (Doypack | (Doypack | (Doypack | (Doypack |
| gas released | | | yellowing | slightly | slightly | swollen and |
| in the | | | and start of | swollen and | swollen and | delaminated |
| packaging | | | degradation) | delaminated, | delaminated | yellowing) |
| | | | | yellowing) | yellowing) | |
| | Test 5-PE | 0 ppm | 0.01 ppm | 0.01 ppm | 0.01 ppm | 0.01 ppm |
| | | | (Doypack ok) | (Doypack ok) | (Doypack ok) | (Doypack ok) |

TABLE 9
Monitoring of the chlorine smell by a consumer panel

| | | | T = 1 | T = 2 | T = 3 | T = 4 |
|---|---|---|---|---|---|---|
| Test | Test | T = 0 | week | weeks | weeks | weeks |
| Measurement of | Test 6-NF | 6 | 8 | 8 | 8 | 10 |
| the chlorine smelt | Test 5-PE | 0 | 0 | 0 | 0 | 2 |

The results of this study show that the use of a Flowpack based on polyethylene (PE) of 30 μm (test 5-PE) makes it possible to improve the stability of the tablets because the disintegration time increases slightly and the concentration of active chlorine remains stable unlike the non-film wrapped tablets (Test 6-PE). In addition, the measurement of the released gases and the measurement of the chlorine smell by the consumer panels show that the Flowpack makes it possible to retain the chlorine gas released inside the Flowpack.

### Example 3: Comparison of the Disintegration Time of Tablets Packaged According to the Invention with Non-Film Wrapped Tablets

In this example, we compared the disintegration time of two tablets based on NaDCC strictly identical in composition, weight, shape and implementation thereof.

The tested tablets have a weight of 5 grams, of cylindrical shape of diameter 20 mm. The composition of these two tablets is summarised in table 10 below:

TABLE 10
Composition of the tested tablets

| | Percentage by weight compared |
|---|---|
| Name | to the total weight |
| NaDCC | 80 |
| Sodium bicarbonate | 12 |
| Adipic acid | 8 |

Two tablets were produced on a rotary press, with the same compressive force. One tablet was film wrapped (test 7-PVOH) in a water soluble film based on polyvinyl alcohol (PVAL) of 30 μm using a laboratory Flowpacker. The other tablet was not film wrapped (test 8-NF). The disintegration time of the two tablets was measured statically in a beaker of 1 litre of water at 20° C. The results obtained are given in table 11 below.

TABLE 11
Monitoring of the disintegration of the tablets

| | Test 8-NF | Test 7-PVOH |
|---|---|---|
| Disintegration time | 4 minutes | 4 minutes |
| Presence of residues | A lot of residues | Very few residues |

When the two tablets were immersed in a beaker of water, we observed the following points:
The tablet alone sinks directly to the bottom of the beaker
The film wrapped tablet floats on the surface of the water. The dissolution of the tablet begins when water infiltrates inside the Flowpack, thus making the pastille break up. At the end of one minute, the lower part of the Flowpack is completely dissolved, thus releasing the whole of the tablet in powder form which falls like rain to the bottom of the beaker.

The results of this study show that the use of a water soluble Flowpack based on PVOH with tablets containing NaDCC make it possible to obtain a tablet having both good dissolution and a rapid disintegration time. The granules of NaDCC being completely dissolved, the tablet is efficient more rapidly than the non-film wrapped tablet. The solution prepared with the film wrapped tablet is ready to use.

### Example 4: Comparison of the Stability of the Secondary Packaging of Tablets Packaged According to the Invention with Non-Film Wrapped Tablets and with Chlorine Free Dishwasher Tablets, Film Wrapped or not

For this example, we took the reference known in the dishwasher market: SUN. The products were constituted in the following manner: several tens of chlorine free tablets were film wrapped in a water soluble film (PVOH) then introduced into a plastic bag of airtight polymeric type acting as secondary packaging. The whole assembly was next arranged in a non-airtight cardboard box in order to come close to the conditions of commercially available products.

Our interest focused on the use of the airtight bag as secondary packaging: does it swell in the presence of a high level of humidity or not? Can the type of packaging used by SUN for dishwasher tablets be duplicated for chlorine?

In this example, we observed the appearance of the plastic bag in different configurations:
the bag contains 30 SUN dishwasher tablets or 30 chlorine tablets according to example 1 (NaDCC)
the tablets may be individually wrapped in a polymer film or not
the bag is placed in an environment at ambient temperature (25° C. and 37% relative humidity on average) and or in a climatic chamber (38° C. and 46% relative humidity)

The results are grouped together in table 12 below. In this table, the following abbreviations are used:
LV=SUN dishwashing tablet;
CL=chlorine tablet according to example 1;
AA=environment at ambient temperature (25° C. and 37% relative humidity on average);
EC=climatic chamber (38° C. and 46% relative humidity);
X=no;
∫=yes; and
T=time.

The results of this study show that the use of a polymer film and humidity have no impact on the SUN dishwasher product because there is no release observed, thus no swelling of the bag is observed.

On the other hand, for the non-film wrapped chlorine tablets, a swelling of the secondary packaging is observed, whether in an environment at ambient temperature or a humid environment.

It is also observed that the use of film wrapped chlorine tablets makes it possible to avoid this swelling. Indeed, the airtight bag does not swell when the chlorine tablet is film wrapped, whether the bag is placed in an environment at ambient temperature or in a humid environment. Within the scope of the present invention, humidity and temperature thus do not have any impact on the swelling of the secondary packaging, notably the airtight secondary packaging.

We can thus conclude that there indeed exists an interaction between the chlorine tablet and the secondary packaging and that this interaction does not result from the external environment. We can also conclude that the Flowpack reduces the interaction between the chlorine tablet and the air present in the bag, avoiding swelling of the secondary packaging used.

TABLE 12
study of the swelling of the secondary packaging

| | Test 1 | Test 2 | Test 3 | Test 4 | Test 5 | Test 6 | Test 7 | Test 8 |
|---|---|---|---|---|---|---|---|---|
| Type of | LV | LV | LV | LV | CL | CL | CL | CL |
| tablets | | | | | | | | |
| (dishwasher or | | | | | | | | |
| chlorine) | | | | | | | | |
| Presence of a | X | √ | X | √ | X | √ | X | √ |
| water soluble | | | | | | | | |
| polymer film | | | | | | | | |
| Airtight | √ | √ | √ | √ | √ | √ | √ | √ |
| secondary | | | | | | | | |
| packaging | | | | | | | | |
| Ambient air or | AA | AA | EC | EC | AA | AA | EC | EC |
| Climatic | | | | | | | | |
| chamber | | | | | | | | |
| T = 1 week | No swelling | No swelling | No swelling | No swelling | No swelling | No swelling | No swelling | No swelling |
| T = 2 weeks | No swelling | No swelling | No swelling | No swelling | Slight | No swelling | Slight | No swelling |
| | | | | | swelling | | swelling | |
| T = 3 weeks | No swelling | No swelling | No swelling | No swelling | Slight | No swelling | Important | No swelling |
| | | | | | swelling | | swelling | |
| T = 4 weeks | No swelling | No swelling | No swelling | No swelling | Slight | No swelling | Important | No swelling |
| | | | | | swelling | | swelling | |

1. Packaging (3) comprising at least one tablet (1) individually wrapped in a polymer film (2), the tablet comprising 5% to 100% of active chlorine releasing agent.

2. Packaging of claim 1, wherein the tablet comprises 5% to 99.9% of active chlorine releasing agent.

3. Packaging of claim 1, wherein the tablet comprises 7.5% to 99.9%, of active chlorine releasing agent.

4. Packaging of claim 1, wherein the packaging is a bag.

5. Packaging of claim 1, wherein the packaging is an airtight packaging.

6. Packaging of claim 1, wherein the active chlorine releasing agent is chosen from dichloroisocyanurates.

7. Packaging of claim 6, wherein the active chlorine releasing agent is sodium dichloroisocyanurate, potassium dichloroisocyanurate, or mixtures thereof.

8. Packaging claim 1, wherein the polymer film comprises a film-forming agent chosen from polyvinyl alcohol, a polymer of biological origin based on corn starch or milk protein, polypropylene, bi-oriented polypropylene, metallised polypropylene, polyethylene, polyolefins, polyethylene terephthalate and polyvinyl chloride.

9. Packaging of claim 1, wherein the polymer film has a thickness comprised between 10 and 100 μm.

10. Method for preparing a packaging (3) comprising at least one tablet (1) individually wrapped in a polymer film (2), the tablet comprising 5% to 100%, by weight of active chlorine releasing agent, the method comprising the following steps:
a) preparing the tablet (1) comprising 5% to 100% by weight of active chlorine releasing agent;
b) incorporating the tablet (1) obtained at step a) in the polymer film (2);
c) closing the polymer film wrapping the tablet (1);
d) optionally, repeating steps a) to c) until the desired number of wrapped tablets is obtained;
e) cutting the polymer film after step c) or step d);
f) incorporating the wrapped tablet(s) obtained at step e) in the packaging (3); and
g) closing the packaging (3).

11. Method according of claim 10, wherein the tablet comprises 7.5% to 99.9%, of active chlorine releasing agent.

12. Method of claim 10, wherein the packaging is a bag.

13. (canceled)

14. (canceled)

15. (canceled)

16. (canceled)

17. Packaging of claim 1, wherein the tablet comprises 20 to 99.9%, of active chlorine releasing agent.

18. Packaging of claim 1, wherein the packaging is an airtight bag.

19. Method of claim 10, wherein the tablet comprises 5% to 99.9%, by weight of active chlorine releasing agent.

20. Method of claim 10, wherein the tablet comprises 20 to 99.9% of active chlorine releasing agent.

21. Method of claim 10, wherein the packaging is an airtight bag.
